(19) United States
(12) Patent Application Publication
(10) Pub. No.: US 2026/0146713 A1
(43) Pub. Date: May 28, 2026

(54) FUEL GAS SUPPLY DEVICE

(71) Applicant: Tokico System Solutions, Ltd., Kanagawa (JP)

(72) Inventors: Minoru TANABE, Kakegawa-shi (JP); Ryohei YAMAMOTO, Kakegawa-shi (JP)

(73) Assignee: Tokico System Solutions, Ltd., Kanagawa (JP)

(21) Appl. No.: 19/113,515

(22) PCT Filed: Dec. 5, 2023
(86) PCT No.: PCT/JP2023/043481

§ 371 Date: Dec. 17, 2025

(30) Foreign Application Priority Data
Dec. 15, 2022 (JP) 2022-200127

(51) Int. Cl. F17C 5/06; F17C 13/00

(52) U.S. Cl. CPC F17C 5/06; F17C 13/002; F17C 2205/0376; F17C 2221/012; F17C 2270/0139

(57) ABSTRACT

A hydrogen gas charging device (1) is provided with a gas supply pipeline (5), a hose (6), a nozzle (7), a breakaway coupling (31) and a speed reduction mechanism (41). The breakaway coupling (31) is provided between the gas supply pipeline (5) and the hose (6) and separates the gas supply pipeline (5) and the hose (6) from each other in an emergency. When the breakaway coupling (31) is separated to a nozzle-side coupling (31A) and a counter nozzle-side coupling (31B), the speed reduction mechanism (41) reduces a speed of the separated nozzle-side coupling (31A). The speed reduction mechanism (41) is provided with a hose guide (41A) and a buffer member (41B) provided in the hose guide (41A).

### TECHNICAL FIELD

The present invention relates to a fuel gas supply device (fuel gas charging device) that supplies (charges) fuel gas of hydrogen gas or the like into a fuel tank (a charged tank) in a vehicle, for example.

### BACKGROUND ART

For example, Patent Document 1 discloses a fuel gas charging device that charges hydrogen gas into a fuel tank (a charged tank) mounted on a vehicle through a nozzle (charging nozzle) provided in an end part of a hose (charging hose). The fuel gas charging device is provided with a breakaway coupling (emergency breakaway coupling) in the middle of the hose. Therefore, for example, when the vehicle starts up in error in a state where the nozzle is being connected to the fuel tank in the vehicle, the hose can be separated due to the separating of the breakaway coupling.

### PRIOR ART DOCUMENT

### Patent Document

Patent Document 1: Japanese Patent Laid-Open No. 2020-060283 A

### SUMMARY OF THE INVENTION

Incidentally, in some cases the breakaway coupling in the fuel gas charging device is separated even in a case other than the erroneous startup of the vehicle, for example, following the hose being excessively pulled. At this time, there is a possibility that the breakaway coupling is vigorously separated based upon a high pressure of the fuel gas therein. In this case, unfortunately the separated breakaway coupling collides with another device to damage the other device or the separated breakaway coupling.

One of objects of the present invention is to provide a fuel gas supply device that can reduce a speed of a separated breakaway coupling.

A fuel gas supply device according to an aspect of the present invention preferably comprises a gas supply pathway for supplying fuel gas to a tank, a nozzle that is provided on the side of one end of the gas supply pathway to be connected to the tank, and a breakaway coupling that is provided in the middle of the gas supply pathway to separate the gas supply pathway to one side that is on the side of the nozzle and the other side that is on the opposite side to the nozzle, characterized by including a speed reduction mechanism located closer to the side of the nozzle than the breakaway coupling in the middle of the gas supply pathway, wherein the speed reduction mechanism, when the breakaway coupling is separated to a nozzle-side coupling and a counter nozzle-side coupling, reduces a speed of the separated nozzle-side coupling.

According to the aspect of the present invention, the speed of the separated breakaway coupling can be reduced.

### BRIEF DESCRIPTION OF THE DRAWINGS

FIG. 1 is an overall configuration diagram schematically showing a fuel gas charging device according to an embodiment.

FIG. 2 is a side view showing a breakaway coupling, a speed reduction mechanism and the like.

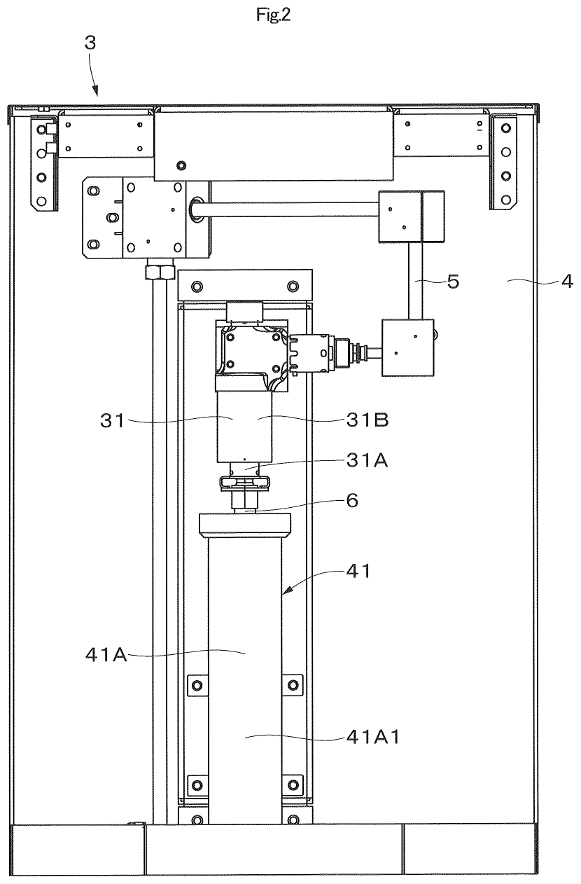

FIG. 3 is a perspective view showing the breakaway coupling, the speed reduction mechanism, a hose, a nozzle and the like.

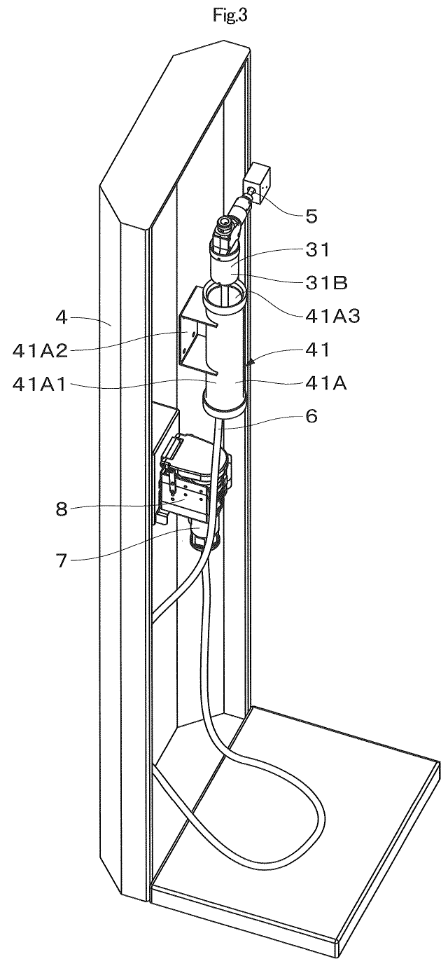

FIG. 4 is a perspective view showing the breakaway coupling, the speed reduction mechanism and the like in FIG. 3 in an enlarging manner.

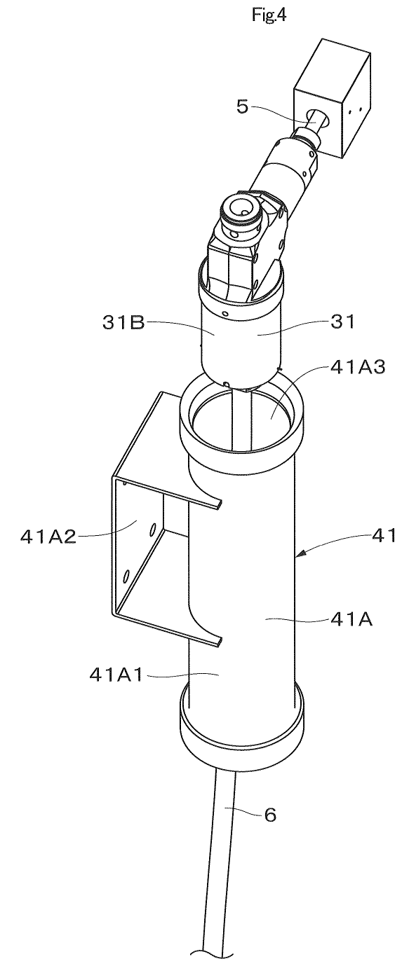

FIG. 5 is a side view showing (A) the breakaway coupling before separated and (B) the breakaway coupling after separated.

FIG. 6 is a side view, partly broken, showing the speed reduction mechanism.

FIG. 7 is an exploded perspective view showing the speed reduction mechanism according to a modification example.

### MODE FOR CARRYING OUT THE INVENTION

Hereinafter, a vehicular hydrogen gas charging device, which charges hydrogen gas into a fuel tank (a charged tank) mounted on a vehicle, taken as an example of a fuel gas supply device according to an embodiment will be described in detail with reference to the accompanying drawings.

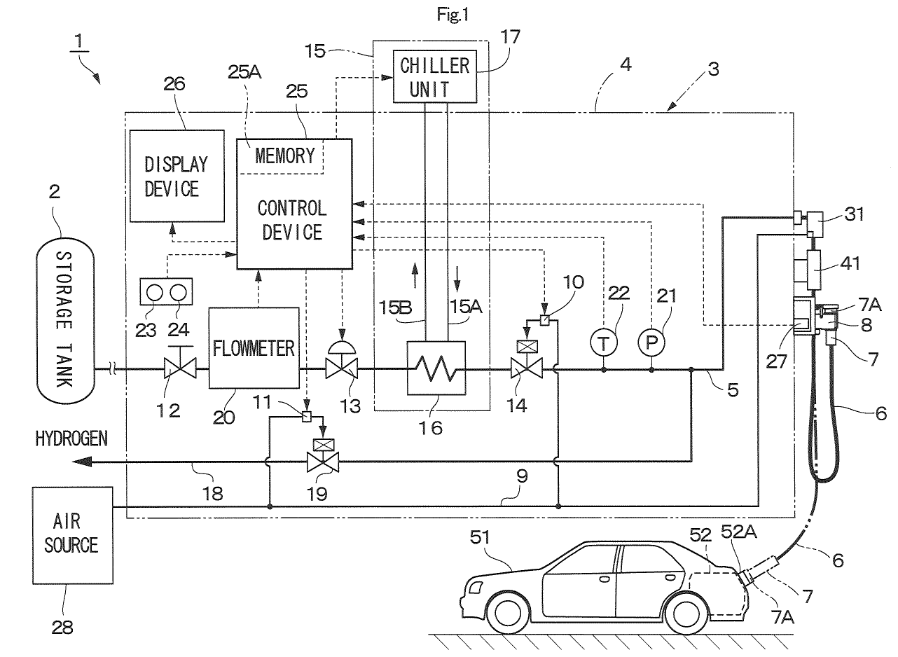

In FIG. 1, a hydrogen gas charging device 1 is a fuel gas charging device (fuel gas supply device) that charges (supplies) compressed hydrogen gas (gas) into a fuel tank 52 (hereinafter, referred to as a tank 52) in a vehicle 51, such as a fuel-cell vehicle (FCV). The hydrogen gas charging device 1 as the vehicular fuel gas charging device (fuel gas supply device) is installed in a facility (fuel supply facility) called a hydrogen gas supply station (hydrogen gas station), for example. The hydrogen gas charging device 1 is configured to include a gas accumulator 2 as a gas storage part (storage tank) for storing hydrogen gas compressed to a high pressure, a dispenser unit 3 as a charging mechanism (fuel gas charging mechanism) for charging hydrogen gas from the gas accumulator 2 into the tank 52 in the vehicle 51, and a gas supply pipeline 5 which extends from the gas accumulator 2 into the inside of a dispenser housing 4 of the dispenser unit 3.

The gas accumulator 2 is a supply source of hydrogen gas for storing the hydrogen gas compressed to a high pressure. The gas accumulator 2 is connected to the dispenser unit 3. The gas accumulator 2 forms the gas storage part on the upstream side of the gas supply pipeline 5 for storing the hydrogen gas compressed to the high pressure. The gas supply pipeline 5 extends from the gas accumulator 2 toward the dispenser unit 3 and is located inside the dispenser housing 4 of the dispenser unit 3. The gas supply pipeline 5 is connected via a hose 6 and a nozzle 7 of the dispenser unit 3 to the tank 52 in the vehicle 51. The gas supply pipeline 5 and the hose 6 form a gas supply pathway for supplying hydrogen gas as fuel gas to the tank 52 of the vehicle 51.

The dispenser unit 3 includes the dispenser housing 4, the hose 6, the nozzle 7, a nozzle retainer 8, a flow rate adjusting valve 13, a shutoff valve 14, a heat exchanger 16, a flowmeter 20, a pressure sensor 21, a temperature sensor 22, a charging start switch 23, a charging stop switch 24, a control device 25 and the like. The dispenser housing 4 forms a housing (box body) as an outline of the dispenser unit 3. The dispenser housing 4 is formed, for example, in a cuboid shape (in a boxy shape) long in an upper-lower direction. The gas supply pipeline 5, the flow rate adjusting valve 13, the shutoff valve 14, the heat exchanger 16, the pressure sensor 21, the temperature sensor 22, the control device 25 and the like are accommodated in the dispenser housing 4. A display device 26 is provided on the front surface side, which faces a worker and a customer carrying out a charging work of hydrogen gas, of the dispenser housing 4 to display the information for informing a charging amount or the like.

The nozzle retainer 8 in which the nozzle 7 is removably retained is provided on the side of the side surface of the dispenser housing 4. The nozzle retainer 8 corresponds to a holding part for holding the nozzle 7. The nozzle 7 is retained in the nozzle retainer 8 at the non-charging time of hydrogen gas (that is, the standby time of the charging work). In other words, the nozzle retainer 8 holds the nozzle 7 except for the time of charging the hydrogen gas into the tank 52 in the vehicle 51. At the time of charging the hydrogen gas into the tank 52 in the vehicle 51, the nozzle 7 is removed from the nozzle retainer 8 by a worker of the charging work.

As shown in FIG. 1, the gas supply pipeline 5 is arranged in the dispenser housing 4 and supplies the pressurized hydrogen gas from the gas accumulator 2 toward the hose 6-side. The gas supply pipeline 5 is configured such that the gas accumulator 2-side becomes the upstream side and the hose 6-side becomes the downstream side. The hose 6 as a gas supplying connection passage extending to an exterior of the dispenser housing 4 is connected to an end part of the gas supply pipeline 5 on the downstream side.

The hose 6 as a charging hose has flexibility. The hose 6 is formed using a pressure-tight hose, for example. The nozzle 7 that is connected to a charging port 52A of the tank 52 is provided on a tip end of the hose 6. The hose 6 configures a gas supply pathway (gas charging pathway) together with the gas supply pipeline 5. The gas supply pathway (gas charging pathway) is a pathway (pipeline) for supplying (charging) gas (hydrogen gas) into the vehicle 51 (tank 52) traveling by using gas (hydrogen gas) as fuel.

A base end side of the hose 6 is connected to the downstream end of the gas supply pipeline 5. In this case, a breakaway coupling 31 also called an emergency breakaway coupling is provided between an end part of the gas supply pipeline 5 on the downstream side and an end part of the hose 6 on the upstream side. The breakaway coupling 31 connects the hose 6 and the gas supply pipeline 5, for example. The breakaway coupling 31 is a safety device to be separated in an emergency. The breakaway coupling 31 is separated when the vehicle 51 starts up in error in a state where the nozzle 7 is being connected to the vehicle 51 (tank 52) in the middle of charging the hydrogen gas or after completion of the charging. That is, the breakaway coupling 31 is separated when the hose 6 is pulled with a strong force. The breakaway coupling 31 is provided with a valve element (shutout valve) for blocking the hydrogen gas from releasing from the gas supply pipeline 5 and the hose 6 when separated.

The nozzle 7 as a charging nozzle is connected to the tip end side of the hose 6 in an air-tight state. The nozzle 7 configures a so-called charging coupling. The nozzle 7 is connected to the gas supply pipeline 5 in the dispenser housing 4 via the hose 6. An on-off valve (not shown) is housed in the nozzle 7. The on-off valve is switched to “an open position” permitting flow of hydrogen gas and “a closed position” shutting off the flow of hydrogen gas. It should be noted that a check valve may be provided on the nozzle 7 instead of or together with the on-off valve. The check valve permits the flow of the hydrogen gas from the nozzle 7 into the tank 52 and blocks the flow of the hydrogen gas from the tank 52 into the nozzle 7.

A tip end side of the nozzle 7 is formed as a connection coupler 7A. The connection coupler 7A is removably connected to the charging port 52A as a connection port of the tank 52. That is, the connection coupler 7A of the nozzle 7 is removably connected to the charging port 52A of the tank 52 in an air-tight state when the hydrogen gas is supplied into the tank 52 in the vehicle 51 via a pipeline (not shown) in the nozzle 7. In addition, the nozzle 7 is provided with a lock mechanism (not shown) by which the nozzle 7 is locked to be capable of being engaged to/disengaged from the charging port 52A of the tank 52. As a result, the nozzle 7 can be suppressed from being inadvertently disengaged from the charging port 52A at the charging of hydrogen gas.

The high-pressure hydrogen gas in the gas accumulator 2 is charged into the tank 52 in the vehicle 51 via the gas supply pipeline 5, the hose 6 and the nozzle 7 in a state where the nozzle 7 is locked to the charging port 52A of the tank 52 by the lock mechanism. That is, the hydrogen gas charging device 1 is provided with the nozzle 7 and charges the hydrogen gas into the tank 52 in the vehicle 51 by using this nozzle 7.

As shown in FIG. 1, the dispenser unit 3 is provided with an inlet valve 12, the flow rate adjusting valve 13 as a control valve and a shutoff valve 14 as a valve unit which are respectively positioned in the middle of the gas supply pipeline 5. The inlet valve 12 is opened/closed by a manual operation, for example. The flow rate adjusting valve 13 is located downstream of the inlet valve 12 and adjustably controls a flow rate of fuel flowing in the gas supply pipeline 5 by being opened/closed by the control device 25. The shutoff valve 14 is located closer to the downstream side than the flow rate adjusting valve 13. It should be noted that the arrangement (the mounting order) of the flowmeter 20, the flow rate adjusting valve 13 and the shutoff valve 14 that are arranged from the upstream side toward the downstream side in the gas supply pipeline 5 is not limited to the order as shown in FIG. 1.

The inlet valve 12 is provided in the middle of the gas supply pipeline 5 to be positioned in the dispenser housing 4. The inlet valve 12 is attached as needed and may be omitted if unnecessary. The flow rate adjusting valve 13, the shutoff valve 14 and a depressurization valve 19 configure the control equipment that controls the flow of hydrogen gas (for example, a flow rate and pressure of hydrogen gas) flowing in the gas supply pipeline 5. The flowmeter 20, the pressure sensor 21 and the temperature sensor 22 configure the measurement equipment that measures conditions (that is, the flow rate, pressure and temperature) of the hydrogen gas flowing in the gas supply pipeline 5.

The flow rate adjusting valve 13 is provided in the dispenser housing 4 to be positioned in the middle section of the gas supply pipeline 5 (for example, between the flowmeter 20 and the shutoff valve 14). The flow rate adjusting valve 13 is an electromagnetic valve unit and is controlled to open/close based upon a signal from the control device 25. In this case, the flow rate adjusting valve 13 is controlled to any opening degree by a command based upon a control program of the control device 25 to variably control the flow rate and the pressure of the hydrogen gas flowing in the gas supply pipeline 5. That is, the flow rate adjusting valve 13 is adjusted to a necessary opening degree when a valve opening degree thereof is controlled based upon a control signal supplied from the control device 25.

The shutoff valve 14 is provided in the middle section of the gas supply pipeline 5 (for example, on the downstream side of the heat exchanger 16). The shutoff valve 14 is a valve unit of a pneumatic operation type and opens by supply of compressed air (air), for example. That is, the shutoff valve 14 opens by supply of the compressed air, instrumentation air or compressed air also called drive gas (including gas other than compressed nitrogen gas or the like) via an air supply pipeline 9 as a drive gas supply passage. Therefore, the air supply pipeline 9 is connected to the shutoff valve 14 to supply the compressed air. The shutoff valve 14 is a normal-closed valve of maintaining a closed valve state when the compressed air equal to or more than a predetermined pressure is not supplied thereto. In this case, the compressed air to be supplied to the shutoff valve 14 is controlled by an electromagnetic valve 10 provided in the middle of the air supply pipeline 9.

The electromagnetic valve 10 is a normal-closed type electromagnetic valve that is regularly in a closed valve position, for example, and is connected to the control device 25. The electromagnetic valve 10 opens by supply of the control current from the control device 25. The shutoff valve 14 opens by supply of the compressed air via the electromagnetic valve 10 of which the opening/closing is controlled based upon the control current supplied from the control device 25. At this time, the shutoff valve 14, in a case where compressed air supplied thereto has a predetermined pressure (or higher than the predetermined pressure), is maintained in a valve opening state by this compressed air.

In this way, the shutoff valve 14 is opened/closed based upon the control signal from the control device 25 to permit or shut off the flow of the hydrogen gas (fuel gas or charging gas) in the gas supply pipeline 5. In this case, the control device 25 executes the opening/closing control in relation to the flow rate adjusting valve 13 and the shutoff valve 14 at the time of charging the hydrogen gas into the tank 52 in the vehicle 51 via the nozzle 7 or stopping (finishing) the charging of the hydrogen gas thereinto.

A cooler 15 is a cooling device for cooling the hydrogen gas flowing in the gas supply pipeline 5. The cooler 15 cools the hydrogen gas in the middle position of the gas supply pipeline 5 for suppressing a temperature rise of the hydrogen gas to be charged into the tank 52 in the vehicle 51. That is, the cooler 15 cools the hydrogen gas to be supplied into the vehicle 51 (tank 52) via the gas supply pipeline 5. The cooler 15 includes the heat exchanger 16 and a chiller unit 17 provided with drive mechanisms of a compressor, a pump and the like. The heat exchanger 16 is provided in the middle section of the gas supply pipeline 5 (for example, between the flow rate adjusting valve 13 and the shutoff valve 14). The chiller unit 17 is connected via refrigerant pipelines 15A, 15B to the heat exchanger 16.

The cooler 15 is provided with the refrigerant pipeline 15A on the supply side for supplying refrigerant (for example, a liquid containing ethylene glycol or the like) from the chiller unit 17 toward the heat exchanger 16-side and the refrigerant pipeline 15B on the return side for returning back the refrigerant after the heat exchanging from the heat exchanger 16 toward the chiller unit 17-side. The chiller unit 17 circulates the refrigerant via the refrigerant pipelines 15A, 15B between the chiller unit 17 and the heat exchanger 16. Thereby, the heat exchanger 16 in the cooler 15 performs the heat exchange between the hydrogen gas flowing in the gas supply pipeline 5 and the refrigerant to reduce a temperature of the hydrogen gas to be supplied toward the hose 6 to a specified temperature (for example, −33° C. to −40° C.).

A depressurization pipeline 18 is provided to be branched from the hydrogen gas supply pipeline 5 downstream of the shutoff valve 14 in the gas supply pipeline 5 to depressurize a gas pressure from the hose 6-side, for example. A depressurization valve 19 is provided in the middle of the depressurization pipeline 18. When the charging work of the hydrogen gas using the hose 6 (nozzle 7) is completed and the shutoff valve 14 is closed, the depressurization valve 19 is controlled to open based upon a signal from the control device 25.

That is, in a case of removing the connection coupler 7A of the nozzle 7 from the charging port 52A of the tank 52, it is necessary to reduce the pressure in the hose 6 to an atmospheric pressure level. Therefore, at the completion time of the gas charging work, a tip end side of the depressurization pipeline 18 is opened to the atmosphere by temporarily opening the depressurization valve 19. Thereby, the hydrogen gas on the hose 6-side is released to an exterior to reduce the pressure in the hose 6 to the atmospheric pressure level. As a result, the connection coupler 7A of the nozzle 7 can be removed from the charging port 52A of the tank 52.

The depressurization valve 19 is a valve unit of a pneumatic operation type and opens by cutting off compressed air (air), for example. That is, the depressurization valve 19 closes by supply of the compressed air via the air supply pipeline 9. Therefore, the air supply pipeline 9 is connected to the depressurization valve 19 as well to supply the compressed air. The depressurization valve 19 is a normal-open valve that closes when the compressed air equal to or more than a predetermined pressure is supplied thereto, for example. The compressed air to be supplied to the depressurization valve 19 is controlled by an electromagnetic valve 11 provided in the middle of the air supply pipeline 9.

The electromagnetic valve 11 is a normal-open type electromagnetic valve that is regularly in a valve opening position, for example. The electromagnetic valve 11 is connected to the control device 25. The electromagnetic valve 11 closes by supply of the control current from the control device 25. The depressurization valve 19 opens by stopping the supply of the compressed air by the electromagnetic valve 11 of which the opening/closing is controlled based upon the control current supplied from the control device 25. That is, when the compressed air supplied thereto becomes lower than a predetermined pressure, the depressurization valve 19 is maintained to be open. In this way, the depressurization valve 19 is opened/closed based upon the control signal from the control device 25 to permit or shut off the flow of the hydrogen gas (fuel gas or charging gas) in the depressurization pipeline 18. In this case, the control device 25 executes the opening/closing control in relation to the depressurization valve 19 when the charging work of the hydrogen gas is completed.

The Coriolis flowmeter 20 is provided in the dispenser housing 4 to be positioned in the middle section of the gas supply pipeline 5 (for example, closer to the upstream side than the flow rate adjusting valve 13) to measure a mass flow rate of a measured liquid. The flowmeter 20 measures a flow rate (mass flow rate) of the hydrogen gas flowing in the gas supply pipeline 5 between the inlet valve 12 and the flow rate adjusting valve 13, for example. The flowmeter 20 outputs the measurement result (detection signal) to the control device 25. The control device 25 calculates a charging quantity of the hydrogen gas into the tank 52 in the vehicle 51 and displays a delivery quantity of hydrogen gas fuel on the display device 26 or the like. Thereby, the display content is notified to a customer or the like, for example.

The pressure sensor 21 is provided in the gas supply pipeline 5 to be positioned closer to the downstream side than the shutoff valve 14 (that is, the nozzle 7-side). The pressure sensor 21 detects a pressure of the hydrogen gas to be supplied from the gas accumulator 2 (that is, a pressure in the middle of the pipeline). The pressure sensor 21 measures the pressure in the gas supply pipeline 5 in the vicinity of the nozzle 7. The pressure sensor 21 outputs a detection signal in accordance with the measured pressure to the control device 25.

The temperature sensor 22 is provided in the middle of the gas supply pipeline 5 to be positioned between the shutoff valve 14 and the pressure sensor 21. The temperature sensor 22 detects a temperature of the hydrogen gas flowing in the gas supply pipeline 5. The temperature sensor 22 outputs the detection result (detection signal) to the control device 25. It should be noted that an arrangement relationship between the temperature sensor 22 and the pressure sensor 21 is not limited to the arrangement as shown in FIG. 1, but, for example, an arrangement therebetween in reverse to each other may be adopted.

The control device 25 configures a controller (control unit) that controls the flow rate adjusting valve 13, the shutoff valve 14 (electromagnetic valve 10), the depressurization valve 19 (electromagnetic valve 11), the display device 26 and the like. The control device 25 controls fuel supply into the tank 52 as a charging target by executing control of the flow rate adjusting valve 13 and the shutoff valve 14 (electromagnetic valve 10). The control device 25 is a control circuit and is configured by a microcomputer including, for example, a CPU (calculation device), a memory 25A (memory device), a timer and the like.

As shown in FIG. 1, the flowmeter 20, the pressure sensor 21, the temperature sensor 22, a humidity sensor (not shown), the charging start switch 23, the charging stop switch 24, a nozzle detector 27 and the like are connected to an input side of the control device 25. On the other hand, an output side of the control device 25 is connected to the flow rate adjusting valve 13, the shutoff valve 14 (electromagnetic valve 10), the depressurization valve 19 (electromagnetic valve 11), the display device 26 and the like.

The display device 26 is provided on the front surface side of the dispenser housing 4. The display device 26 is located in a height position where a worker performing the charging work of the hydrogen gas can easily confirm visually. The display device 26 performs information display and the like necessary for the charging work of the hydrogen gas. In addition, in a case where the breakaway coupling 31 to be described later is separated, the warning (error) is displayed on the display device 26. Operating parts of the charging start switch 23, the charging stop switch 24 and the like in addition to the display device 26 are arranged on the front surface side of the dispenser housing 4. In addition, a POS terminal (not shown) which displays and manages sales information is provided in a position adjacent to the display device 26 on the front surface side of the dispenser housing 4.

The charging start switch 23 and the charging stop switch 24 are switches that can manually be operated by a worker of a fuel supply station (hydrogen station), for example. The charging start switch 23 is operated at the time of starting the charging of the hydrogen gas, and the charging stop switch 24 is operated at the time of stopping the charging of the hydrogen gas in the middle of charging the hydrogen gas. The charging start switch 23 and the charging stop switch 24 respectively output signals in accordance with the operating states to the control device 25. Thereby, the control device 25 opens or closes the shutoff valve 14 in response to these signals.

As shown in FIG. 1, a nozzle detector 27 is provided on the nozzle retainer 8. The nozzle detector 27 detects whether or not the nozzle 7 is retained. The nozzle detector 27 is configured by a switch (nozzle switch), for example, a switch of a two-position switching type and is connected to the control device 25. The nozzle detector 27, for example, when the nozzle 7 is retained in the nozzle retainer 8, is pushed and moved by the nozzle 7 to be switched to an on-state (ON). The nozzle detector 27, when the nozzle 7 is removed (detached) from the nozzle retainer 8, is switched to an off-state (OFF).

The nozzle detector 27 outputs a detection signal (an on-signal or an off-signal) corresponding to whether or not the nozzle 7 is retained in the nozzle retainer 8 to the control device 25. It should be noted that a relationship between ON (ON: power supply) and OFF (OFF: non-power supply) may be reversed. That is, when the nozzle 7 is removed from the nozzle retainer 8, the nozzle 7 is switched from OFF to ON. The nozzle detector 27 is not limited to being provided on the nozzle retainer 8 in the dispenser housing 4-side but may be provided in the nozzle 7-side. In any case, the nozzle 7 is held in the nozzle retainer 8 of the dispenser unit 3 at the non-charging time of the hydrogen gas (that is, at the standby time of the charging work). That is, when the charging work for charging the hydrogen gas into the tank 52 in the vehicle 51 is finished, the nozzle 7 is returned back to the nozzle retainer 8 to be held in an accommodating state.

The vehicle 51 to be driven and traveled by using the hydrogen gas as fuel is configured by a four-wheeled car (passenger car) as shown in FIG. 1, for example. The vehicle 51 is provided with, for example, a drive device (not shown) including a fuel cell and an electric motor, the tank 52 as shown in a dotted line in FIG. 1, and the like. The tank 52 is configured as a container of a pressure structure for charging the hydrogen gas. The tank 52 is mounted on the rear part side of the vehicle 51, for example. The tank 52 is provided, not limited to the rear part side of the vehicle 51 but may be provided to the front part side or the central part side of the vehicle 51.

The tank 52 is provided with the charging port 52A (receptacle) to which the connection coupler 7A of the nozzle 7 is removably attached. The charging of the hydrogen gas is performed into the tank 52 in the vehicle 51 in a state where the nozzle 7 is air-tightly connected to the charging port 52A in the vehicle 51. At this time, the nozzle 7 is locked by the lock mechanism in such a way as to be prevented from inadvertently being disengaged from the charging port 52A.

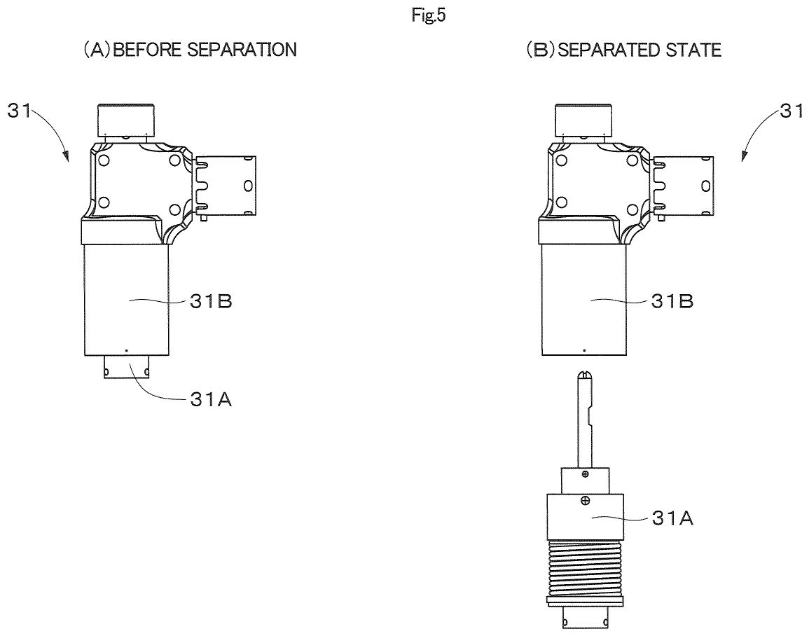

Incidentally, the breakaway coupling 31 is separated, for example, when the vehicle 51 starts up in error in a state where the nozzle 7 is connected to the tank 52 in the vehicle 51, by being subjected to tension loading via the hose 6. In this case, as shown in FIG. 5, the breakaway coupling 31 is separated to a nozzle-side coupling 31A on the vehicle 51-side and a counter nozzle-side coupling 31B on the dispenser unit 3-side. At this time, a valve body installed in each of the couplings 31A, 31B in the breakaway coupling 31 prevents the release of the hydrogen gas to an exterior.

The breakaway coupling 31 is thought to be separated, for example, when excessively pulled following the hose 6 being forcibly pulled around or being stepped on. At this time, the nozzle-side coupling 31A as a part to be separated on the vehicle 51-side is possibly separated vigorously based upon a high gas pressure therein. At this time, that is, after the breakaway coupling 31 is separated, the nozzle-side coupling 31A collides with another device to damage the other device or the nozzle-side coupling 31A collides with the ground vigorously to be damaged, which is not preferable.

On the other hand, the separation of the breakaway coupling 31 is interrupted when the vehicle 51 starts up in error and the function for preventing the release of hydrogen gas in the breakaway coupling 31 is interrupted, both of which are not preferable. Therefore, it is not preferable to change the structure of the separation mechanism of the breakaway coupling 31. Accordingly in the embodiment, the dispenser unit 3 is provided with a mechanism (speed reduction mechanism 41) for suppressing the momentum of a portion to be separated on the vehicle 51-side (nozzle-side coupling 31A) when the breakaway coupling 31 is separated. As a result, the pop-out of the portion to be separated on the vehicle 51-side, that is, the nozzle-side coupling 31A as the vehicle-side separation portion is suppressed without changing the structure of the separation mechanism of the breakaway coupling 31. Hereinafter, this respect will in detail be explained.

First of all, as shown in FIG. 1, the hydrogen gas charging device 1 is provided with the gas supply pipeline 5 and the hose 6 as a gas supply pathway, the nozzle 7 also called the charging nozzle and the breakaway coupling 31 also called an emergency breakaway coupling. The gas supply pipeline 5 and the hose 6 are the gas supply pathway for supplying the hydrogen gas as fuel gas to the tank 52 as a supply target of hydrogen gas. The nozzle 7 is provided on the tip end side of the hose 6 as one end side of the gas supply pathway. The nozzle 7 is connected to the tank 52. The breakaway coupling 31 is provided in the middle of the gas supply pathway, more specifically between the gas supply pipeline 5 and the hose 6. It should be noted that in the embodiment the breakaway coupling 31 is provided between the gas supply pipeline 5 and the hose 6 but, for example, the breakaway coupling may be provided in the middle of a hose or in the middle of a gas supply pipeline. That is, the breakaway coupling may be provided in the middle of the gas supply pathway (for example, between the gas supply pipeline and the hose, in the middle of the hose or in the middle of the gas supply pipeline).

The breakaway coupling 31 causes the gas supply pathway to be separated to “one side that is on the nozzle 7-side” and “the other side that is on the opposite side to the nozzle 7”. That is, the breakaway coupling 31 causes the gas supply pathway to be separated to “a hose 6-side” that is on the nozzle 7-side and “a gas supply pipeline 5-side” that is on the opposite side to the nozzle 7. Therefore, as shown in FIG. 5, the breakaway coupling 31 is provided with the nozzle-side coupling 31A and the counter nozzle-side coupling 31B. On top of that, the nozzle-side coupling 31A is connected (fixed) to the base end side of the hose 6. Thereby, the nozzle-side coupling 31A and the nozzle 7 are connected on one side of the gas supply pathway by the hose 6 having flexibility. On the other hand, the counter nozzle-side coupling 31B is connected (fixed) to the downstream end of the gas supply pipeline 5. That is, the counter nozzle-side coupling 31B is fixed to the dispenser unit 3-side and is held to the dispenser unit 3-side even when the breakaway coupling 31 is separated.

The breakaway coupling 31 is configured so that in a normal time the nozzle-side coupling 31A and the counter nozzle-side coupling 31B are connected and in an emergency the nozzle-side coupling 31A and the counter nozzle-side coupling 31B are separated. That is, the nozzle-side coupling 31A and the counter nozzle-side coupling 31B are separated when a prescribed tension load is applied therebetween. Therefore, the nozzle-side coupling 31A and the counter nozzle-side coupling 31B are connected by, for example, a share pin (not shown) that is broken by being subjected to a prescribed force.

It should be noted that the connection between the nozzle-side coupling 31A and the counter nozzle-side coupling 31B is not limited to use of the pin structure by the share pin but may be made, for example, by use of an adhesive agent of which an adhesive surface is separated when a prescribed force or more are applied thereto or by use of a mechanism of a ball lock or the like. That is, the connection between the nozzle-side coupling 31A and the counter nozzle-side coupling 31B may be made by adopting various configurations that are separated by being subjected to a prescribed tension load. In any case, a valve body (shutoff valve) is provided in the nozzle-side coupling 31A to block the hydrogen gas in the hose 6 from being released to an exterior when separated. A valve body (shutoff valve) is provided in the counter nozzle-side coupling 31B to block the hydrogen gas from being released to an exterior from the gas supply pipeline 5 when separated.

As shown in FIG. 1, the breakaway coupling 31 is connected to the air supply pipeline 9. More specifically the counter nozzle-side coupling 31B is connected to the air supply pipeline 9. In addition, an opening of the downstream end in the air supply pipeline 9 provided in the counter nozzle-side coupling 31B is closed by the nozzle-side coupling 31A in a state where the counter nozzle-side coupling 31B and the nozzle-side coupling 31A are connected. When the breakaway coupling 31 is separated, that is, the nozzle-side coupling 31A is separated from the counter nozzle-side coupling 31B, the opening of the downstream end in the air supply pipeline 9 is exposed and the compressed air in the air supply pipeline 9 flows out to an exterior through this opening.

Thereby, when the breakaway coupling 31 is separated, the shutoff valve 14 is closed regardless of the opening/closing of the electromagnetic valves 10, 11 in the air supply pipeline 9, thus making it possible to open the depressurization valve 19. That is, the electromagnetic valve 10 and the electromagnetic valve 11 open by the control device 25 in the middle of the charging of the hydrogen gas, whereby the shutoff valve 14 is opened and the depressurization valve 19 is closed. Also in this case, when the breakaway coupling 31 is separated, the compressed air in the air supply pipeline 9 is not to be supplied to the shutoff valve 14 and the depressurization valve 19, and it is possible to close the shutoff valve 14 and open the depressurization valve 19.

Therefore, as shown in FIG. 1, the hydrogen gas charging device 1 is provided with a compressor 28 and the air supply pipeline 9 as a compressed air supply pipeline. The compressor 28 is a compressed air supply source (a compressed air supply source, an instrumentation air supply source and a compressed gas supply source) for supplying the compressed air. The compressed air from the compressor 28 flows in the air supply pipeline 9. The compressor 28 and the air supply pipeline 9 supply the compressed air to control equipment devices of the shutoff valve 14, the depressurization valve 19 and the like that are driven using the compressed air as a drive source. In addition, the air supply pipeline 9 is connected to the breakaway coupling 31 so that when the breakaway coupling 31 is separated, the shutoff valve 14 can close and the depressurization valve 19 can open. It should be noted that nonflammable gas of nitrogen gas or the like in addition to the compressed air may be used as the compressed air to be supplied from the compressor 28.

The compressor 28 generates compressed air (compressed air, instrumentation air and drive gas) for driving the valve units of a pneumatic operation type of the shutoff valve 14, the depressurization valve 19 and the like. The compressor 28 is a compressor to be driven by a drive source of an electric motor or the like and supplies the compressed air through the air supply pipeline 9 to the shutoff valve 14, the depressurization valve 19, the breakaway coupling 31 and the like. The air supply pipeline 9 is arranged in the dispenser housing 4. The air supply pipeline 9 establishes connection between the compressor 28 and the shutoff valve 14 and the depressurization valve 19.

The air supply pipeline 9 establishes connection between the compressor 28 and the breakaway coupling 31. When the breakaway coupling 31 is separated, the opening of the downstream end in the air supply pipeline 9 closed by the nozzle-side coupling 31A is exposed and the compressed air in the air supply pipeline 9 flows out through this opening to an exterior. Accordingly, even when the electromagnetic valves 10, 11 are opened, the compressed air is not to be supplied to the shutoff valve 14 and the depressurization valve 19. As a result, the shutoff valve 14 as a normal closed valve closes and the depressurization valve 19 as a normal open valve opens.

Further, in the embodiment the dispenser unit 3 is provided with a speed reduction mechanism 41 that reduces the speed (separating speed and moving speed) of the nozzle-side coupling 31A when the breakaway coupling 31 is separated. The speed reduction mechanism 41 is provided in the dispenser housing 4 of the dispenser unit 3. In this case, the speed reduction mechanism 41 is fixed to the dispenser housing 4. When the breakaway coupling 31 is separated to the nozzle-side coupling 31A and the counter nozzle-side coupling 31B, the speed reduction mechanism 41 reduces the separating speed (moving speed) of the separated nozzle-side coupling 31A.

Therefore, the speed reduction mechanism 41 is located closer to the nozzle 7-side than the breakaway coupling 31 in the middle of the hose 6 configuring part of the gas supply pathway (in other words, between the breakaway coupling 31 and the nozzle 7). More specifically, the speed reduction mechanism 41 is located under the breakaway coupling 31 (nozzle-side coupling 31A) in the middle of the hose 6 and is fixed to the dispenser housing 4.

The speed reduction mechanism 41 is provided with a hose guide 41A as a restriction member and a buffer member 41B provided in the hose guide 41A. The hose guide 41A is configured as a tubular body in a substantially cylindrical shape and is fixed to the dispenser housing 4. That is, the hose guide 41A is provided with a tubular part 41A1 in which the hose 6 is inserted and a bracket part 41A2 that attaches the tubular part 41A1 to the dispenser housing 4. The hose guide 41A is fixed via the bracket part 41A2 to the dispenser housing 4 by using a fixing member of bolts (not shown) or the like.

Here, the hose 6 is inserted in the hose guide 41A. Because of this configuration, the hose guide 41A is therein provided with a passage 41A3 through which the separated nozzle-side coupling 31A passes. The hose guide 41A restricts a direction in which the nozzle-side coupling 31A and the hose 6 are separated (direction of being away from the counter nozzle-side coupling 31B). In this case, the hose guide 41A restricts the separating direction of the separated nozzle-side coupling 31A to the direction in which the hose 6 extends. Therefore, a part, which is lower than the connection part between the hose 6 and the nozzle-side coupling 31A, of the base end side of the hose 6 is inserted in the hose guide 41A.

Because of this configuration, when the nozzle-side coupling 31A is separated from the counter nozzle-side coupling 31B, the separated nozzle-side coupling 31A passes through the inside of the hose guide 41A together with the hose 6 toward the lower side as a direction in which the hose 6 comes out of the inside of the hose guide 41A. Thereby, the track of the nozzle-side coupling 31A is restricted to the direction in which the hose 6 extends by the hose guide 41A. In this way, the hose guide 41A has a function of guiding the nozzle-side coupling 31A in the same direction as the hose 6 in addition to a function of guiding the hose 6.

On the other hand, the buffer member 41B configuring part of the speed reduction mechanism 41 together with the hose guide 41A is provided in the passage 41A3 of the hose guide 41A. The buffer member 41B abuts on an outer surface of the nozzle-side coupling 31A. In the embodiment, the buffer member 41B is configured by a plurality of contact pieces 41B1. The contact pieces 41B1 each are formed with a plate member of substantially a semicircle (for example, a resin plate in a ruck shape) having the same radius of curvature as that of an inner peripheral surface of the hose guide 41A. The contact pieces 41B1 are fixed to the inner peripheral surface of the hose guide 41A. The contact pieces 41B1 are arranged to axially line up in the hose guide 41A in a state of radially opposing to each other (in a state of radially putting the hose 6 therebetween). In this case, the buffer member 41B (contact pieces 41B1) is inclined to the separating direction of the nozzle-side coupling 31A to be separated. That is, the contact pieces 41B1 are fixed to the inner peripheral surface of the hose guide 41A in a state where a section, which is positioned on a center shaft side of the hose guide 41A, of the contact piece 41B1 is inclined toward the side lower than the other section.

In this way, in the embodiment the breakaway coupling 31 is provided with the nozzle-side coupling 31A and the counter nozzle-side coupling 31B. The breakaway coupling 31 is separated to “the nozzle-side coupling 31A pulled to the vehicle side” and “the counter nozzle-side coupling 31B remaining in the dispenser housing 4-side”. In addition, the tubular hose guide 41A is provided under the breakaway coupling 31 so that the nozzle-side coupling 31A can vertically be separated. When the breakaway coupling 31 is separated, the nozzle-side coupling 31A passes through the inside of the tubular hose guide 41A and is separated from the dispenser unit 3 together with the nozzle 7 and the hose 6.

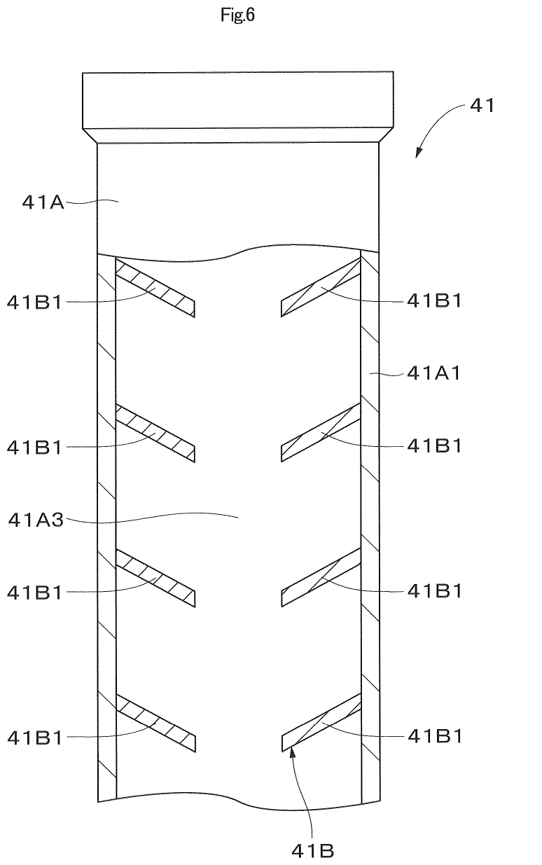

As shown in FIG. 6, the contact pieces 41B1 each of which is composed of the resin plate in the ruck shape are arranged in the hose guide 41A to oppose to each other in a radial direction of the hose guide 41A and line up in an axial direction of the hose guide 41A. The contact pieces 41B1 configure the buffer member 41B that reduces the speed of the nozzle-side coupling 31A by abutting on the nozzle-side coupling 31A at the separating of the breakaway coupling 31. That is, when the nozzle-side coupling 31A passes through the inside of the hose guide 41A, the nozzle-side coupling 31A moves while deforming the buffer member 41B (contact pieces 41B1). Because of this, the momentum of the nozzle-side coupling 31A is suppressed (the speed is lowered). The contact piece 41B1 is configured by a resin plate (resin plate in a ruck shape) formed in a substantially semicircle shape similar to a shape by dividing a disc into halves, for example. The contact pieces 41B1 are incorporated in the hose guide 41A. The contact piece 41B1 is formed with, for example, a resin of flexible polyvinyl chloride resin or the like to prevent the separation force of the nozzle-side coupling 31A from being affected.

The buffer member 41B (contact pieces 41B1) may be shaped to abut on an outer peripheral surface of the hose 6 or to be spaced from the outer peripheral surface of the hose 6 in the hose guide 41A. In a case of causing an inner radius side of the buffer member 41B (contact pieces 41B1) to abut on the outer peripheral surface of the hose 6, the buffer member (abutting member) can be formed in an annular shape or in a semi-annular shape so that a radial inside thereof is in line with the outer peripheral surface of the hose 6. In a case of this configuration, when the breakaway coupling 31 is separated, the moving speed (separating speed) of the hose 6 including the breakaway coupling 31 also can be lowered by sliding contact between the inner radius side of the buffer member (abutting member) in the annual shape or in the semi-annular shape and the outer peripheral surface of the hose 6.

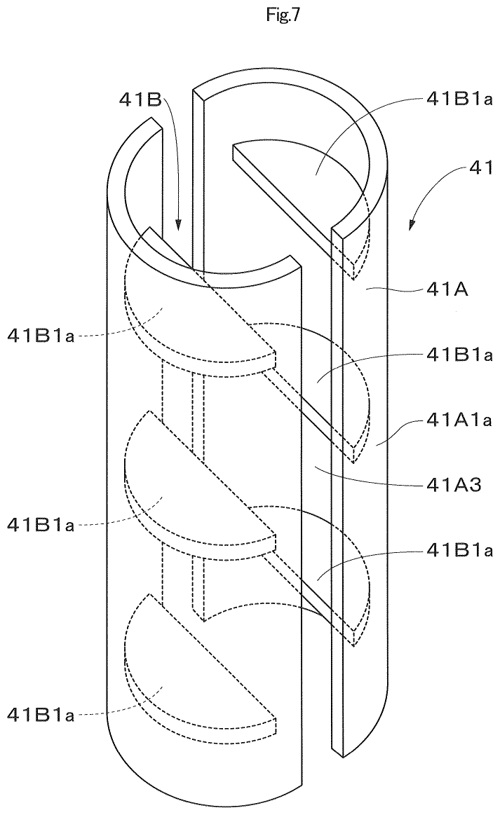

That is, the speed reduction mechanism 41 (buffer member 41B) may be configured to apply a speed reducing force (braking force) to the nozzle-side coupling 31A by abutting on (sliding contact with) the nozzle-side coupling 31A. The speed reduction mechanism 41 (buffer member 41B) may be configured to apply a speed reducing force (braking force) to the hose 6 by abutting on (sliding contact with) the hose 6. The speed reduction mechanism 41 (buffer member 41B) may be configured to apply a speed reducing force (braking force) to both of the nozzle-side coupling 31A and the hose 6 by abutting on (sliding contact with) both of them. In addition, the buffer member 41B may be configured so that the contact pieces 41B1a are arranged to alternate (in a step shape), as shown in a modification example in FIG. 7, for example. In the modification example as shown in FIG. 7, a tubular part 41A1a of the hose guide 41A is formed in a cylindrical shape by butting a pair of semicylindrical members. Omitted in illustration but the buffer members may be provided in a grit shape in a tubular hose guide.

The hydrogen gas charging device 1 according to the embodiment has the configuration as described above, and next, an explanation will be made of the charging work of the hydrogen gas by the hydrogen gas charging device 1.

When the hydrogen gas is charged into the tank 52 in the vehicle 51, a worker performing the charging work removes the nozzle 7 from the nozzle retainer 8. In addition, as shown by a dashed-two dotted line in FIG. 1, the nozzle 7 is connected to the charging port 52A of the tank 52 and the corresponding connection section is locked. In this state, when the worker of the charging work turns on the charging start switch 23, the control device 25 outputs an opening signal to the flow rate adjusting valve 13 and the shutoff valve 14 (electromagnetic valve 10) to open the flow rate adjusting valve 13 and the shutoff valve 14.

Thereby, the hydrogen gas in the gas accumulator 2 is charged via the gas supply pipeline 5, the hose 6 and the nozzle 7 into the tank 52 in the vehicle 51. The control device 25 adjusts the opening degree of the flow rate adjusting valve 13 and the like by a preset control system (for example, a constant-pressure rise control system or constant-flow rate control system) while monitoring the measurement result of the flowmeter 20, the pressure sensor 21 and the temperature sensor 22, for example. Thereby, the pressure and the flow rate of the hydrogen gas to be supplied into the gas supply pipeline 5 can be controlled to an appropriate flowing state.

At this time, the control device 25 integrates flow rate pulses from the flowmeter 20 to calculate a charging quantity (mass) of the hydrogen gas and determines whether or not the charging quantity of the hydrogen gas has reached a preset target charging quantity or whether or not the pressure of the hydrogen gas detected by the pressure sensor 21 has reached a preset target charging pressure. When the charging quantity of the hydrogen gas is determined to have reached the target charging quantity (pressure), the flow rate adjusting valve 13 and the shutoff valve 14 (electromagnetic valve 10) are closed in response to signals from the control device 25 to finish the charging of the hydrogen gas into the tank 52. It should be noted that also in a case where a worker operates the charging stop switch 24, the charging work is finished.

Next, the control device 25 executes the charging finish control processing in this state. In this charging finish control processing, the depressurization valve 19 (electromagnetic valve 11) is controlled to open from the closing state in response to a signal from the control device 25. When the depressurization valve 19 is opened, the depressurization pipeline 18 is released to the atmosphere, by which the gas on the nozzle 7-side is released to an exterior to reduce the pressure in the nozzle 7 to an atmospheric pressure level. In this state, a worker can remove the connection coupler 7A of the nozzle 7 from the charging port 52A of the tank 52.

The nozzle 7 removed from the charging port 52A of the tank 52 is returned back to the nozzle retainer 8 on the dispenser housing 4-side by a worker and is retained thereto by a manual operation. The nozzle detector 27 provided on the nozzle retainer 8 detects whether or not the nozzle 7 is returned back to the nozzle retainer 8. When the nozzle 7 is returned back to the nozzle retainer 8 and is retained thereto, a detection signal from the nozzle detector 27 is outputted to the control device 25. Thereby, the control device 25 determines that the charging work by the nozzle 7 is finished and becomes in the standby state to the next charging work.

In addition, when the hose 6 is pulled by the erroneous startup of the vehicle or the like to separate the breakaway coupling 31, the nozzle-side coupling 31A passes through the inside of the hose guide 41A configuring part of the speed reduction mechanism 41 together with the hose 6. That is, according to the embodiment, the speed reduction mechanism 41 is located closer to the nozzle 7-side than the breakaway coupling 31 to reduce the speed of the separated nozzle-side coupling 31A. Therefore, the separated nozzle-side coupling 31A is decelerated by the speed reduction mechanism 41. That is, the separating speed of the nozzle-side coupling 31A is reduced by the speed reduction mechanism 41. Because of this, caused by the contact between the nozzle-side coupling 31A and another equipment device, a damaging degree of the other equipment device and a damaging degree of the nozzle-side coupling 31A can be reduced.

According to the embodiment, the speed reduction mechanism 41 is provided with the hose guide 41A as a restriction member for restricting the moving direction (separating direction) of the nozzle-side coupling 31A and the buffer member 41B abutting on the outer surface of the nozzle-side coupling 31A. Therefore, the separating direction of the nozzle-side coupling 31A is restricted by the hose guide 41A, and the braking force can be applied to the nozzle-side coupling 31A by the buffer member 41B. This configuration can suppress the contact between the nozzle-side coupling 31A and another equipment device from damaging the other equipment device and from damaging the nozzle-side coupling 31A.

According to the embodiment, the hose guide 41A restricts the moving direction (separating direction) of the separated nozzle-side coupling 31A to the direction in which the hose 6 extends. Therefore, the nozzle-side coupling 31A can be separated in the same direction as the hose 6. Because of this configuration, it is possible to suppress the breakaway coupling 31 from being incapable of being separated by interference of the hose 6 with the nozzle-side coupling 31A.

According to the embodiment, the plurality of contact pieces 41B1 configuring the buffer member 41B are inclined to the moving direction (separating direction) of the nozzle-side coupling 31A to be separated. Therefore, when the breakaway coupling 31 is separated, the nozzle-side coupling 31A can pass through the passage 41A3 of the hose guide 41A. That is, the nozzle-side coupling 31A can be suppressed from remaining in the passage 41A3 of the hose guide 41A by the buffer member 41B (contact pieces 41B1). Because of this, the hose guide 41A can be suppressed from being damaged by excessive tension of the nozzle 7.

It should be noted that the embodiment is explained by taking as an example a case where the buffer member 41B includes the plurality of contact pieces 41B1, and the contact pieces 41B1 are arranged to oppose to each other a pair by a pair in the radial direction of the hose guide 41A and line up in the axial direction thereof. However, not limited thereto but as shown in the modification example in FIG. 7, the contact pieces 41B1a may be arranged to axially alternate (in a step shape). In this case, the contact pieces 41B1a may be arranged to be vertical to a center shaft line of the hose guide 41A, for example. The tubular part 41A1a of the hose guide 41A in FIG. 7 is configured by butting the pair of semicylindrical members for fixation. In addition, omitted in illustration but the buffer member may be configured by a single abutting member in an annular shape or in a cylindrical shape. That is, as to a shape of the buffer member, various shapes may be adopted to be applying a desired decelerating force (braking force) to the nozzle-side coupling and/the hose.

In addition, the embodiment is explained by taking a case where the buffer member 41B includes the contact pieces 41B1 formed with a resin (resin plates in a ruck shape) as an example. However, not limited thereto but the buffer member may be formed by using a donut-shaped balloon (air bag) which inflates in the hose guide using a gas pressure of compressed air (instrumentation air), inert gas or the like. In this case, the balloon (air bag) may be inflated in advance by supply of the compressed air from an air supply source, for example. Further, like a life jacket, a balloon may be configured so that, for example, a pin provided in the balloon (air bag) is disengaged following separation of the breakaway coupling to open a valve therein and thereby, the compressed air (compressed gas) is supplied into the balloon (air bag), which is then inflated.

The embodiment is explained by taking a case where the speed reduction mechanism includes the hose guide 41A and the buffer member 41B as an example. However, not limited thereto but the speed reduction mechanism may be configured as a member different from the hose guide, for example. For example, the speed reduction mechanism is provided as the member different from the hose guide and when the nozzle-side coupling and/or the hose is displaced in a direction away from the dispenser unit, the speed reduction mechanism may be configured by a displacement resisting member as a resistance against this displacement. For example, the speed reduction mechanism, following the nozzle-side coupling and/or the hose being away from the dispenser unit, may be configured by a breaking member that breaks following the resistance therebetween. The breaking member can be provided to bridge between the nozzle-side coupling and/or the hose and the dispenser unit.

In summary, the speed reduction mechanism may adopt various mechanisms that can apply a desired decelerating force (braking force) to the nozzle-side coupling and/or the hose. In this case, the speed reduction mechanism may be configured to remain in or be out of the dispenser unit when the breakaway coupling is separated (for example, move together with the nozzle-side coupling and/or the hose).

The embodiment is explained by taking a case where the supply source of the compressed air to be supplied to the air supply pipeline 9 is composed of the compressor 28 as an example. However, not limited thereto but the supply source of the compressed air may be a supply source other than the compressor, such as a gas container (high-pressure gas container or gas bomb) and the like.

The embodiment is explained by taking the automobile as an example of the vehicle 51 on which the tank 52 is mounted. However, not limited thereto but a working vehicle of a forklift or the like may be used as the vehicle. In addition, a shared car of a bus or the like or a freight car of a truck or the like may be used as the automobile, for example.

The embodiment is explained by taking a case where the tank 52 in the vehicle 51 is charged with the hydrogen gas, as an example. However, not limited thereto but the embodiment may be used in a case where a tank (bomb, container or the like) in things other than the vehicle is charged with hydrogen gas. The dispenser unit 3 in the hydrogen gas charging device 1 may be installed in the middle of a pipeline (hydrogen feeding pipeline) for feeding hydrogen gas to the other place. Further, the embodiment is explained by taking the hydrogen gas as an example of gas, but the structure (gas charging device) using gas (fuel gas) other than the hydrogen gas, such as natural gas (NG), propane gas (LPG) or the like may be used.

The embodiment is explained by taking the structure of charging the hydrogen gas into the single vehicle 51 through the gas supply pipeline 5 and the hose 6 in one system by the single dispenser unit 3, that is, a case of a single type dispenser unit (single type charging device), as an example. However, not limited thereto but, for example, the structure of charging fuel gas to one vehicle or a plurality of vehicles through gas supply pipelines and hoses (gas supply connection passages) in a plurality of systems (two or more systems) by one dispenser unit such as a double type dispenser unit (double type charging device) and the like may be used.

According to the embodiment as explained above, the speed reduction mechanism is located closer to the nozzle side than the breakaway coupling in the middle of the gas supply pathway. When the breakaway coupling is separated to the nozzle-side coupling and the counter nozzle-side coupling, the speed reduction mechanism reduces the speed of the separated nozzle-side coupling. Therefore, the separated nozzle-side coupling is decelerated by the speed reduction mechanism. That is, the separating speed of the nozzle-side coupling can be reduced by the speed reduction mechanism. In a case where the contact between the nozzle-side coupling and another equipment device occurs, this configuration can reduce a damaging degree of the other equipment device and a damaging degree of the nozzle-side coupling.

According to the embodiment, the speed reduction mechanism is provided with the restriction member for restricting the separating direction of the nozzle-side coupling and the buffer member abutting on the outer surface of the nozzle-side coupling. Therefore, the separating direction of the nozzle-side coupling is restricted by the restriction member and the breaking force can be applied to the nozzle-side coupling by the buffer member. Because of this, caused by the contact between the nozzle-side coupling and the other equipment device, the other equipment device can be suppressed from being damaged and the nozzle-side coupling can be suppressed from being damaged.

According to the embodiment, the restriction member restricts the separating direction of the separated nozzle-side coupling to the direction in which the hose extends. Therefore, the nozzle-side coupling can be separated in the same direction as the hose. Because of this configuration, it is possible to suppress the breakaway coupling from being incapable of being separated caused by interference of the hose with the nozzle-side coupling.

According to the embodiment, the buffer member is inclined to the separating direction of the nozzle-side coupling to be separated. Therefore, when the breakaway coupling is separated, the nozzle-side coupling can pass through the passage of the restriction member. That is, the nozzle-side coupling can be suppressed from remaining in the passage of the restriction member by the buffer member. Because of this, the restriction member can be suppressed from being damaged by excessive tension of the nozzle.

It should be noted that the embodiment and the modification examples of the present invention are explained, but the present invention is not limited to the above-mentioned embodiment and the modification examples but contains various modification examples. For example, the above-mentioned embodiment and the modification examples are in detail explained for easy understanding of the present invention, and the present invention is not necessarily limited to those provided with all the components as explained. In addition, part of the components in each of the embodiment and the modification examples can be subject to addition, delete or replacement of the other component.

The present application claims the priority based upon Japanese Patent Application No. 2022-200127 of the application dated on Dec. 15, 2022. All the disclosure contents including the specification, the claims, the figures and the abstract in Japanese Patent Application No. 2022-200127 of the application dated on Dec. 15, 2022 are by reference incorporated in the present specification as a whole.

### DESCRIPTION OF REFERENCE NUMERALS

1: HYDROGEN GAS CHARGING DEVICE (FUEL GAS SUPPLY DEVICE)
5: GAS SUPPLY PIPELINE (GAS SUPPLY PATHWAY)
6: HOSE (GAS SUPPLY PATHWAY)
7: NOZZLE
31: BREAKWAY COUPLING
31A: NOZZLE-SIDE COUPLING
31B: COUNTER NOZZLE-SIDE COUPLING
41: SPEED REDUCTION MECHANISM
41A: HOSE GUIDE (RESTRICTION MEMBER)
41A3: PASSAGE
41B: BUFFER MEMBER
41B1, 41B1a: CONTACT PIECE
52: FUEL TANK (TANK)

1. A fuel gas supply device comprising:
a gas supply pathway for supplying fuel gas to a tank;
a nozzle that is provided on the side of one end of the gas supply pathway to be connected to the tank; and
a breakaway coupling that is provided in the middle of the gas supply pathway to separate the gas supply pathway to one side that is on the side of the nozzle and the other side that is on the opposite side to the nozzle side, characterized by including:
a speed reduction mechanism located closer to the side of the nozzle than the breakaway coupling in the middle of the gas supply pathway, wherein the speed reduction mechanism, when the breakaway coupling is separated to a nozzle-side coupling and a counter nozzle-side coupling, reduces a speed of the separated nozzle-side coupling.

2. The fuel gas supply device according to claim 1, wherein
the speed reduction mechanism is provided with:
a restriction member that is provided therein with a passage through which the separated nozzle-side coupling passes to restrict a direction in which the nozzle-side coupling is separated; and
a buffer member that is provided in the passage to abut on an outer surface of the nozzle-side coupling.

3. The fuel gas supply device according to claim 2, wherein
the nozzle-side coupling and the nozzle are connected on one side of the gas supply pathway by a hose having flexibility, and
the restriction member restricts the separating direction of the separated nozzle-side coupling to a direction in which the hose extends.

4. The fuel gas supply device according to claim 2, wherein
the buffer member is inclined to the separating direction of the nozzle-side coupling to be separated.
